(19) United States
(12) Patent Application Publication
(10) Pub. No.: US 2013/0043719 A1
(43) Pub. Date: Feb. 21, 2013

(54) Elastomeric Bearing for Equalizer Bar of Undercarriage

(71) Applicants: Ross P. Wietharn, Peoria, IL (US); Dan J. Becker, Peoria, IL (US); Elavumkal Jacob, Peoria, IL (US)

(72) Inventors: Ross P. Wietharn, Peoria, IL (US); Dan J. Becker, Peoria, IL (US); Elavumkal Jacob, Peoria, IL (US)

(73) Assignee: Caterpillar Inc., Peoria, IL (US)

(21) Appl. No.: 13/588,510

(22) Filed: Aug. 17, 2012

Related U.S. Application Data
(60) Provisional application No. 61/525,014, filed on Aug. 18, 2011.

(51) Int. Cl. F16C 27/02; F16C 33/22; B62D 55/10

(52) U.S. Cl. 305/120; 384/125

(57) ABSTRACT

An elastomeric bearing can be incorporated into a bearing joint assembly of an undercarriage of a track-type machine. The elastomeric bearing can include a plurality of alternating elastomeric layers and metal plies that are configured to allow at least three degrees of relative rotational movement and can allow the relative rotation of roll, pitch, and yaw. The elastomeric bearing can be generally cylindrical with the elastomeric layers and metal plies being generally barrel-shaped such that the cross-section of the elastomeric layers and metal plies define an annular arc that follows an axis of revolution that coincides with a central longitudinal axis thereof.

### CROSS-REFERENCE TO RELATED APPLICATIONS

This patent application claims the benefit of priority to U.S. Provisional Patent Application No. 61/525,014, filed on Aug. 18, 2011, and entitled “Elastomeric Bearing for Equalizer Bar of Undercarriage,” which is incorporated in its entirety herein by this reference.

### TECHNICAL FIELD

This patent disclosure relates generally to a bearing joint arrangement for an undercarriage of a machine and, more particularly, to a bearing joint arrangement for mounting a track assembly frame to an equalizer bar of a track-type machine.

### BACKGROUND

Track-type machines are in widespread use in construction, mining, forestry, and other similar industries. The undercarriage of such track-type machines typically use track assemblies to provide ground-engaging propulsion. Such track assemblies may be preferred in environments where creating sufficient fraction is problematic, such as the environments identified above. Specifically, rather than rolling across a work surface on wheels, track-type machines can use one or more track assemblies that include an endless loop of coupled track links defining exterior surfaces, which support ground-engaging track shoes, and interior surfaces that travel about one or more rotatable track-engaging elements, such as, drive sprockets, idlers, tensioners, and rollers, for example.

Track-type machines can include an equalizer bar pivotably mounted to a main frame and both track assemblies to allow a degree of flexibility in movement of the tracks relative to the main frame. The equalizer bar can be pivotably mounted to the main frame at a center line of both the main frame and the equalizer bar, and the two distal ends of the equalizer bar can be connected to respective track roller frames of the track assemblies. The connection between the equalizer bar and the track roller frame can allow a degree of movement between the equalizer bar and the track roller frame under conditions of severe loading. Equalizer bar designs can include a spherical bearing joint at each opposite end of the equalizer bar for coupling to the track frames of the machine.

As an example of one design for a bearing joint, U.S. Pat. No. 7,789,407 for a “Vehicle With Elastomeric Bearing Suspension System and Elastomeric Bearing Therefor,” which issued on Sep. 7, 2010, to Lefferts et al., is directed to a vehicle suspension system for large vehicles that includes at least one elastomeric bearing. The bearing includes at least one substantially cylindrical elastomeric portion, at least one substantially frustospherical elastomeric portion, and at least one non-extensible shim disposed between and bonded to the substantially cylindrical elastomeric portion and the substantially frustospherical elastomeric portion.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure describes embodiments of an elastomeric bearing. At least one embodiment of the disclosed elastomeric bearings can be used for a bearing joint assembly as described herein. At least one embodiment of the disclosed bearing joint assemblies can be used in an undercarriage of a track-type machine. At least one embodiment provides an elastomeric bearing that does not require lubrication.

In one embodiments, an elastomeric bearing for a bearing joint assembly includes an inner race extending along a longitudinal axis. An outer race is coaxially arranged with the inner race. A plurality of elastomeric layers is disposed between the outer race and the inner race. The elastomeric layers define at least one pair of adjacent elastomeric layers. A metal ply is interposed between the elastomeric layers of at least one pair of adjacent elastomeric layers. The elastomeric layers are adapted to permit relative rotation and translation between the outer race and the inner race. At least a portion of one of the elastomeric layers is in a pre-compressed state.

In some embodiments, an elastomeric bearing includes at least a portion of an elastomeric layer that is placed into a pre-compressed state such that any hydrostatic tensile stresses in the elastomeric layer remain below a predetermined level while being subjected to a given load to help reduce cavitation damage. In some embodiments, an elastomeric bearing includes at least a portion of an elastomeric layer that is placed into a pre-compressed state such that cyclic stress or strain amplitudes in the elastomeric layer remain below a predetermined level while being subjected to a given cyclic loading condition to help reduce fatigue damage.

In another embodiment, a bearing joint assembly includes an elastomeric bearing and a pin. The elastomeric bearing defines an axial passage extending therethrough along a longitudinal axis. The pin is disposed in the axial passage of the bearing and extends along the longitudinal axis. The elastomeric bearing includes an inner race extending along the longitudinal axis. The inner race is in engaging contact with the pin such that the inner race and the pin are coupled together to prevent relative movement therebetween. An outer race is coaxially arranged with the inner race. A plurality of elastomeric layers is disposed between the outer race and the inner race. The elastomeric layers define at least one pair of adjacent elastomeric layers. A metal ply is interposed between the elastomeric layers of at least one pair of adjacent elastomeric layers. The elastomeric layers are adapted to permit relative rotation and translation between the outer race and the inner race. At least a portion of one of the elastomeric layers is in a pre-compressed state.

In yet another embodiment, an undercarriage includes a main frame having a first side. A first track assembly is disposed on the first side of the main frame. An equalizer bar is pivotably connected to the main frame. The equalizer bar includes a first distal end. A first bearing joint assembly pivotably connects the first distal end of the equalizer bar to the first track assembly. The first bearing joint assembly includes an elastomeric bearing and a pin. The elastomeric bearing defines an axial passage extending therethrough along a longitudinal axis. The pin is disposed in the axial passage of the bearing and extends along the longitudinal axis. The elastomeric bearing includes an inner race extending along the longitudinal axis. The inner race is in engaging contact with the pin such that the inner race and the pin are coupled together to prevent relative movement therebetween. An outer race is coaxially arranged with the inner race. A plurality of elastomeric layers is disposed between the outer race and the inner race. The elastomeric layers define at least one pair of adjacent elastomeric layers. A metal ply is interposed between the elastomeric layers of at least one pair of adjacent elastomeric layers. The elastomeric layers are adapted to permit relative rotation and translation between the outer race and the inner race. At least a portion of one of the elastomeric layers is in a pre-compressed state.

In still another embodiment, a method of making an elastomeric bearing for a bearing joint assembly is described. A first subassembly and a second subassembly are abutted together. The first subassembly and the second subassembly each have an inner end. The inner end of the first subassembly and the inner end of the second subassembly are abutted in adjoining relationship to each other and define a circumferential groove therebetween. The first subassembly and the second subassembly form an inner race extending along a longitudinal axis, an outer race coaxially arranged with the inner race, a plurality of elastomeric layers disposed between the outer race and the inner race and defining at least one pair of adjacent elastomeric layers, and a metal ply interposed between the elastomeric layers of at least one pair of adjacent elastomeric layers. The first subassembly and the second subassembly are moved to axially approach each other along the longitudinal axis to close the circumferential groove defined between the first subassembly and the second subassembly, thereby generating an axial compressive pre-load in at least a portion of one of the elastomeric layers.

Further and alternative aspects and features of the disclosed principles will be appreciated from the following detailed description and the accompanying drawings. As will be appreciated, the principles related to elastomeric bearing and bearing joint assemblies disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagrammatic side elevational view of an embodiment of a track- type machine.

FIG. 2 is a diagrammatic end elevational view of an embodiment of an undercarriage arrangement for a track-type machine.

FIG. 3 is a perspective view of an embodiment of a frame for a track-type machine.

FIG. 4 is a fragmentary, detail view, in perspective, of a distal end of an embodiment of an equalizer bar and an embodiment of a bearing joint arrangement for a track-type machine.

FIG. 5 is a view of the bearing joint arrangement as in FIG. 4, but from a different perspective.

FIG. 6 is a schematic representation of an embodiment of a bearing joint arrangement suitable for use in accordance with principles of the present disclosure.

FIG. 7 is a perspective view, in section, of an embodiment of a split-spherical elastomeric bearing in accordance with principles of the present disclosure, showing the elastomeric bearing in an unassembled condition.

FIG. 8 is an enlarged, detail view of the elastomeric bearing of FIG. 7.

FIG. 9 is a view of the elastomeric bearing as in FIG. 7, but showing the elastomeric bearing in an assembled condition.

### DETAILED DESCRIPTION

The present disclosure provides an elastomeric bearing, which can be used in a bearing joint arrangement for an equalizer bar of an undercarriage of a track-type machine. Examples of such machines include machines used for construction, mining, forestry, and other similar industries. In some embodiments, the machine can be a dozer, loader, or excavator, or any other on-highway or off-highway vehicle. The machine can have a track-type undercarriage with first and second track assemblies on opposing sides thereof. The track assemblies can be adapted to engage the ground, or other surface, to propel the track-type machine. While the machine is illustrated in the context of a track-type machine, it should be appreciated that the present disclosure is not thereby limited. For example, embodiments of an elastomeric bearing according to the present disclosure can be used in other machine applications, such as, in an articulated truck A frame head bearing and/or panhard rod bearing.

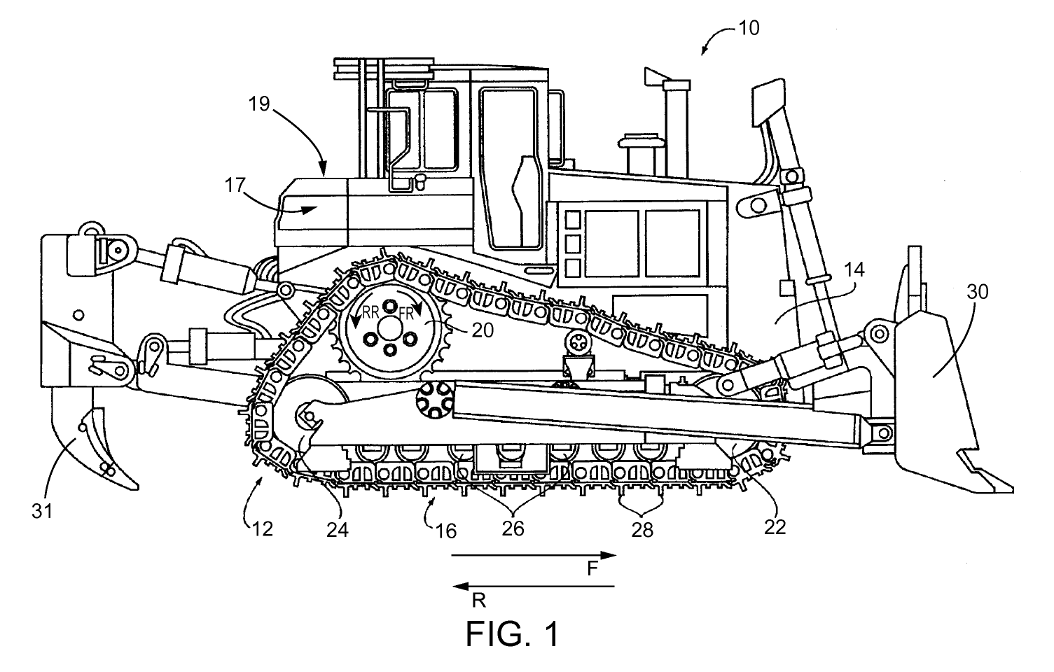

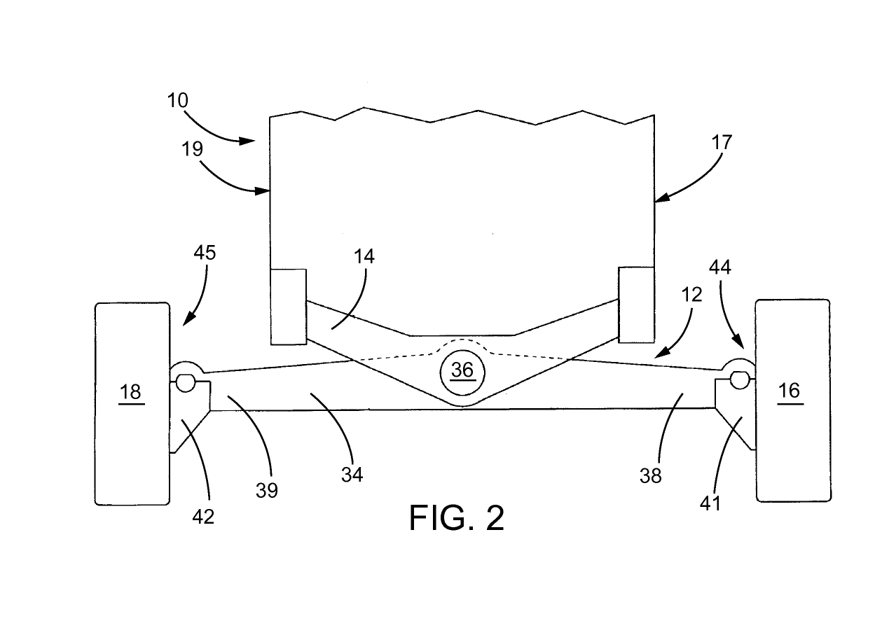

Turning now to the Figures, there is shown in FIGS. 1 and 2 an exemplary embodiment of a machine 10 with a track-type undercarriage 12. The machine 10 may also be referenced herein as a track-type machine. In different embodiments, the machine 10 may be a dozer, loader, excavator, or any other on-highway or off-highway vehicle.

The machine 10 includes a main frame 14 having a first track assembly 16 disposed on a first side 17 thereof and a second track assembly 18 disposed on a second side 19 thereof. The second side 19 is in opposing relationship to the first side 17. The first and second track assemblies 16, 18 are adapted to engage the ground, or other supporting surface, to propel the machine 10.

It should be appreciated that the track assemblies 16, 18 of the machine 10 can be similar and, further, can represent mirror images of one another. As such, only the first track assembly 16 will be described herein. It should be understood that the description of the first track assembly 16 is applicable to the second track assembly 18, as well.

The first track assembly 16 extends about a plurality of rolling elements such as a drive sprocket 20, a front idler 22, a rear idler 24, and a plurality of track rollers 26. The first track assembly 16 includes a plurality of ground-engaging track shoes 28 for engaging the ground, or other supporting surface, and propelling the machine 10.

The track-type machine 10 can be propelled forward by any suitable drive arrangement (not shown), which typically includes a pair of opposing drive shafts connected to the respective drive sprocket 20 of the first and second track assemblies 16, 18. During typical operation of the undercarriage 12, the drive sprocket 20 is driven in a forward rotational direction “FR” to drive the track assembly 16, and thus the machine 10, in a forward direction “F,” and in a reverse rotational direction “RR” to drive the track assembly 16, and thus the machine 10, in a reverse direction “R.” The drive sprockets 20 of the undercarriage 12 can be independently operated to allow the machine 10 to turn.

One or more implements 30, 31 can be mounted to the machine 10 for a variety of tasks, including, for example, moving, loading, lifting, digging, brushing, compacting, etc. Any suitable implement can be used. Examples of suitable implements include, for example, blades, buckets, compactors, forked lifting devices, brushes, grapples, cutters, shears, blades, breakers/hammers, augers, and others.

Referring to FIG. 2, the undercarriage 12 includes an equalizer bar 34 pivotably connected to the main frame 14 via a pivot assembly 36. A first distal end 38 and a second distal end 39 of the equalizer bar 34 are pivotably connected to the first track assembly 16 and the second track assembly 18, respectively. The first distal end 38 and the second distal end 39 of the equalizer bar 34 are pivotably connected to a first track frame 41 of the first track assembly 16 and a second track frame 42 of the second track assembly 18, respectively, via a first bearing joint assembly 44 and a second bearing joint assembly 45. The pivot assembly 36 enables the equalizer bar 34 to rotate about the pivot assembly 36 relative to the main frame 14 to accommodate movement of the first and second track frames 41, 42, which can occur when the machine 10 travels over uneven terrain, for example.

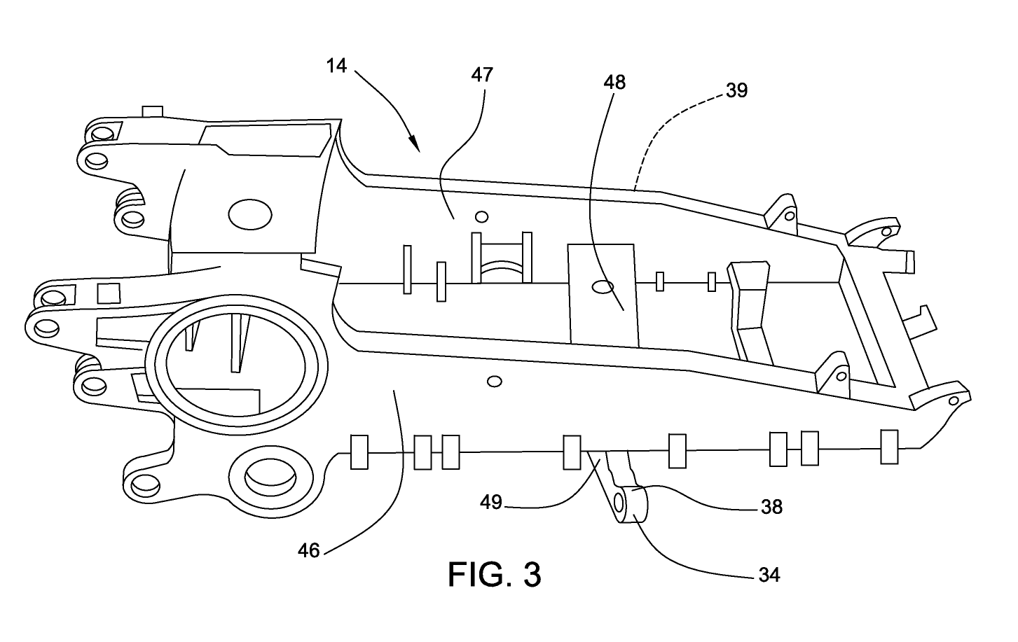

Referring to FIG. 3, the main frame 14 can include first and second plate members 46, 47 that can be connected together by a load support member 48. The load support member 48 can be used to support loads in the main frame 14 transferred from the first and second track frames 41, 42 and the implements 30, 31. The load support member 48 may be referred to as an “equalizer bar saddle.” The load support member 48 can define a channel 49 that is generally straight and extends substantially transversely to the first and second plate members 46, 47. The equalizer bar 34 can extend through the channel 49 and be connected to the load support member 48 via the pivot assembly 36. The first and second plate members 46, 47 can be in generally parallel, spaced relationship to each other such that the first and second distal ends 38, 39 of the equalizer bar 34 project from the first and second plate members 46, 47, respectively.

In other embodiments, undercarriages in accordance with principles of the present disclosure can include different main frames as are known in the art. For example, in other embodiments, an undercarriage can include a frame as shown and described in U.S. Patent Application Publication No. US 2009/0200785, which is entitled, “Machine Frame.”

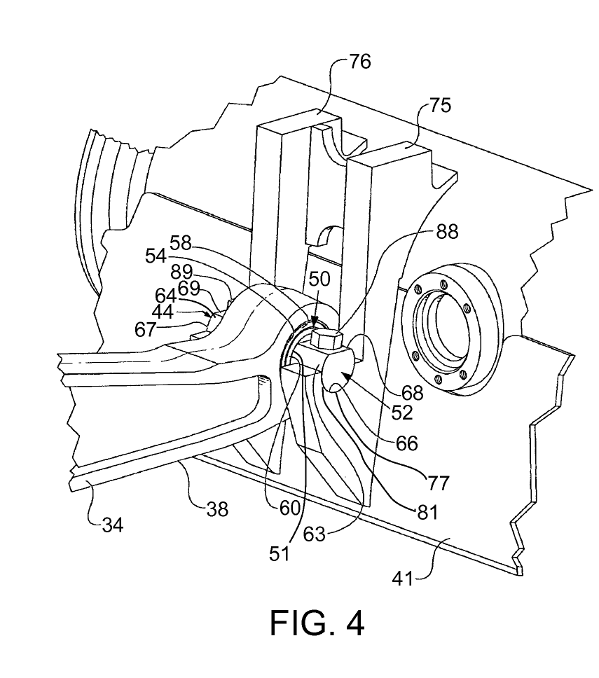

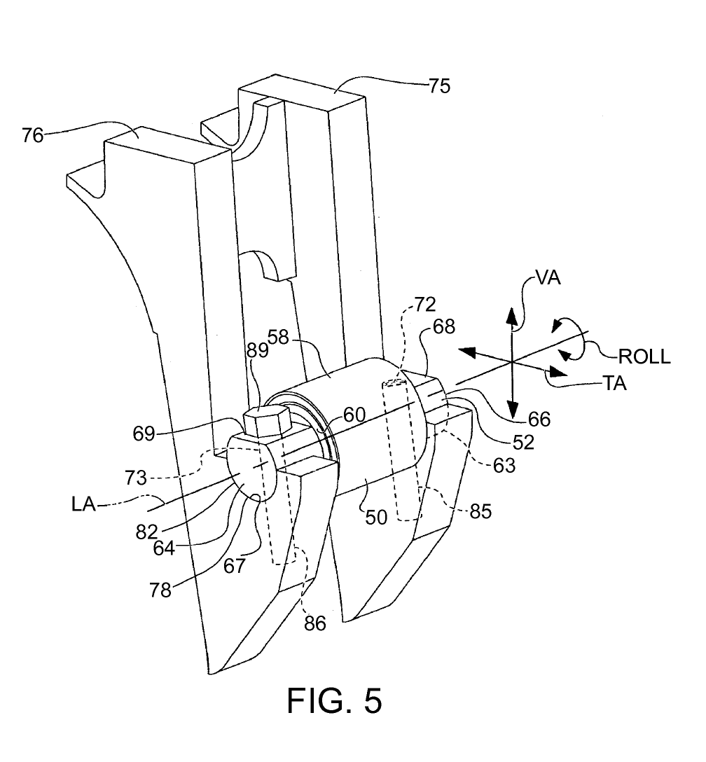

Referring to FIGS. 4 and 5, the first bearing joint assembly 44 pivotably connects the equalizer bar 34 to the first track frame 41. Both the first and second track frames 41, 42 can be mounted to the equalizer bar 34 in the same manner. Accordingly, only the connection between the equalizer bar 34 and the first track frame 41 will be described herein. It should be understood that the connection between the equalizer bar 34 and the second track frame 42 can follow the same principles, as well.

The bearing joint assembly 44 includes an elastomeric bearing 50, which defines an axial passage 51 therethrough, and a pin 52, which is disposed in the axial passage 51 of the elastomeric bearing 50 and extends along a longitudinal axis “LA” through the elastomeric bearing 50. The first distal end 38 of the equalizer bar 34 defines a through passage 54, which is adapted to receive the elastomeric bearing 50 therethrough. The elastomeric bearing 50 is preferably adapted to accommodate a certain degree of misalignment and/or have self-aligning properties. The elastomeric bearing 50 can be held in place in the through passage 54 via any suitable means, such as a snap ring and groove arrangement and/or a press-fit arrangement, for example. The elastomeric bearing 50 in this embodiment has an outer race 58 and an inner race 60 which are arranged such that the outer race 58 can rotate and swivel relative to the inner race 60 during operation of the machine 10.

The outer race 58 is in engaging contact with first distal end 38 of the equalizer bar 34 such that the outer race 58 and the equalizer bar 34 are coupled together to prevent relative movement therebetween. The inner race 60 is in engaging contact with the pin 52 such that the inner race 60 and the pin 52 are coupled together to prevent relative movement therebetween. In the illustrated embodiment, the pin 52 and the inner race 60 are separate components that are joined together using any suitable technique. In other embodiments, the pin 52 and the inner race 60 can be formed together as an integral component. The pin 52 is coupled to the first track frame 41 of the first track assembly 16 to prevent relative movement therebetween.

The elastomeric bearing 50 is coaxially disposed with respect to the pin 52 such that they both extend along the longitudinal axis “LA.” The pin 52 is configured such that the pin 52 extends a predetermined length along the longitudinal axis “LA” that is greater than the length of the axial passage 51 of the elastomeric bearing 50 so that first and second distal portions 63, 64 project from respective opposing faces of the equalizer bar 34. In other embodiments, a portion of the pin 52 can project from a single face of the equalizer bar 34.

The bearing joint assembly 44 permits the equalizer bar 34 and the pin 52 (and, thus, the first track frame 41 of the first track assembly 16) to undergo relative rotation and translation. The equalizer bar 34 and the pin 52 (and, thus, the first track frame 41 of the first track assembly 16) can undergo relative rotation with at least three degrees of rotational freedom to allow relative movement referred to as pitch, yaw and roll. Pitch in this context may be described as relative rotation in a generally vertical plane where the vertical plane is defined by the longitudinal axis “LA” and a vertical axis “VA,” which is perpendicular to the longitudinal axis “LA.” When the elastomeric bearing 50 undergoes relative rotation referred to as pitch, the components of the elastomeric bearing can move relative to each other about a transverse axis “TA,” which is perpendicular to both the longitudinal axis “LA” and the vertical axis “VA.” Yaw is similar to pitch but takes place in a generally horizontal plane where the horizontal plane is defined by the longitudinal axis “LA” and the transverse axis “TA.” When the elastomeric bearing 50 undergoes relative rotation referred to as yaw, the components of the elastomeric bearing can move relative to each other about the vertical axis “VA.” “Roll” is rotational movement about the longitudinal axis “LA.” The bearing joint assembly 44 can be adapted to allow two or more of these types of relative rotation to occur simultaneously. In some embodiments, the three rotational degrees of freedom may be combined or limited in any suitable manner.

The equalizer bar 34 and the pin 52 (and, thus, the first track frame 41 of the first track assembly 16) can undergo relative translation along the longitudinal axis “LA,” which can be permitted as a function of the axial stiffness of the elastomeric bearing 50. Similarly, the radial stiffness of the elastomeric bearing 50 can permit relative translation along the transverse axis “TA” and the vertical axis “VA.”

The first and second distal portions 63, 64 of the pin 52 each has a generally convex surface 66, 67 and a planar surface 68, 69, respectively. The first distal portion 63 of the pin 52 defines a passage 72 extending from the planar surface 68 through the pin 52. Similarly, the second distal portion 64 of the pin 52 defines a passage 73 extending from the planar surface 69 through the pin 52.

In this embodiment, the first track frame 41 is provided with two connection portions in the form of a first bracket 75 and a second bracket 76 which project in a cantilevered fashion from the track frame 41. The first and second brackets 75, 76 respectively define recesses in the form of first and second channels 77, 78, which are substantially aligned with each other. The first and second channels 77, 78 have first and second concave surfaces 81, 82, respectively, which, in this embodiment, have a shape that is substantially complementary to the respective convex surfaces 66, 67 of the first and second distal portions 63, 64 of the pin 52. The first and second concave surfaces 81, 82 can substantially conform to the generally convex surfaces 66, 67 of the first and second distal portions 63, 64 of the pin 52 such that the pin 52 is supported in the first and second channels 77, 78 with a fairly close tolerance fit.

The first and second brackets 75, 76 define passages 85, 86 which in some embodiments can be blind holes having a threaded internal surface and in other embodiments can be through holes which extend from the respective generally convex surface 66, 67 through the whole of the particular bracket 75, 76. When mounted to the first and second brackets 75, 76, the pin 52 can be positioned in the first and second channels 77, 78 such that the passages 72, 73 of the pin 52 are aligned with the passages 85, 86 of the first and second brackets 75, 76, respectively. A pair of fasteners 88, 89 (the fastener 88 for the first distal portion 63 is omitted from FIG. 4) can extend through the passages 72, 73 of the pin 52 and into the passages 5, 86 of the first and second brackets 75, 76, respectively, to thereby couple the pin 52 to the first track frame 41 of the first track assembly 16. In some embodiments, the fasteners 88, 89 can be threaded setscrews that threadingly engage threads located in the 85, 86 of the first and second brackets 75, 76, respectively. In other embodiments, the fasteners 88, 89 can extend through the first and second brackets 75, 76 and be secured thereto via a washer and nut arrangement.

In still other embodiments, an undercarriage constructed in accordance with principles of the present disclosure can include bearing joint assemblies with respective pins which are mounted to first and second track frames using other suitable techniques and structure as are known in the art. For example, in other embodiments, an undercarriage constructed in accordance with principles of the present disclosure can include an equalizer bar and mounting arrangement therefor as shown and described in U.S. Pat. No. 6,298,933, which is entitled, “Equalizer Bar Stop Assembly for Limiting Movement of the Equalizer Bar Relative to the Main Frame of a Track-Type Work Machine.” In yet other embodiments, a pin component without planar surfaces or bolt passages can be secured to a track frame using other techniques.

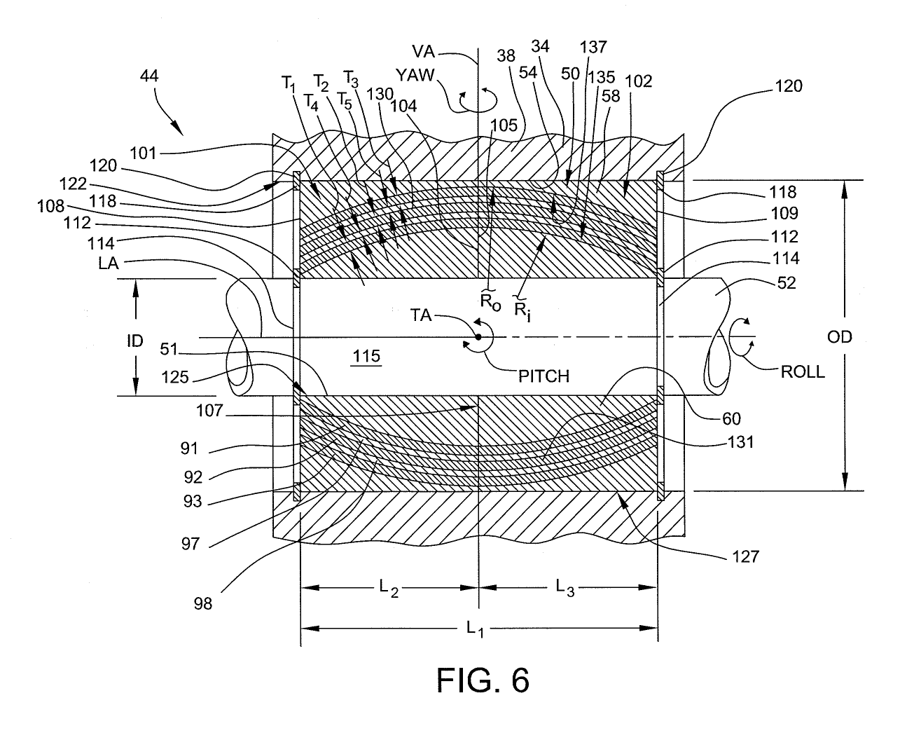

Referring to FIG. 6, the bearing joint assembly 44 can be adapted to support a static load equal to about one-quarter of the weight of the machine 10. In some embodiments, the bearing joint assembly 44 can support a static load along the vertical axis “VA” of at least about 300,000N, and preferably at least about 350,000N, and even more preferably at least 356,727N. The bearing joint assembly 44 can be adapted to support a dynamic load that is equal to approximately the full machine weight. In some embodiments, the bearing joint assembly 44 can support a dynamic load of at least about 800,000N, and preferably at least about 1,000,000N, and even more preferably at least 1,052,345N.

The elastomeric bearing 50 is adapted to permit relative rotation and translation between the inner race 60 and the outer race 58. In some embodiments, the outer race 58 and the inner race 60 can pivot with respect to each other about the longitudinal axis “LA” (roll) over a range of travel of at least about ±3.5°, preferably at least about ±4.25°, and even more preferably at least ±5°. In some embodiments, the outer race 58 and the inner race 60 can pivot with respect to each other about the transverse axis “TA” in the vertical plane (pitch) over a range of travel of at least about ±1.5°, preferably at least about ±2.1°, and even more preferably at least ±3°. In some embodiments, the outer race 58 and the inner race 60 can pivot with respect to each other about the vertical axis “VA” in the horizontal plane (yaw) over a range of travel of at least about ±0.1°, at least about ±0.13°, and even more preferably at least ±0.15°. In some embodiments, the outer race 58 and the inner race 60 can translate with respect to each other along the longitudinal axis “LA” over a range of travel of at least about 1 mm, at least about 1.45 mm, and even more preferably at least about 2 mm.

In other embodiments, the range of travel for one or more degrees of rotational freedom and/or translation can be varied to accommodate a particular application in which the elastomeric bearing 50 is to be used. For example, in the case where the elastomeric bearing 50 is incorporated into a panhard rod bearing, the outer race 58 and the inner race 60 can be adapted to pivot with respect to each other about the longitudinal axis “LA” (roll) over a range of travel of at least about ±9° and about the transverse axis “TA” in the vertical plane (pitch) over a range of travel of at least about ±3.5°. The panhard rod bearing assembly can be adapted to support a static load along the transverse axis “TA” of at least about 195,000N, and preferably at least about 200,000N, and even more preferably at least 225,000N.

In this embodiment, the bearing joint assembly 44 can be considered a “maintenance-free” joint in that it does not require lubrication. The elastomeric bearing 50 can avoid the need to use seals or lubrication during use yet maintain its functionality. As a result, the additional cost requirement for using seals or lubricant can be avoided. Furthermore, the elastomeric bearing 50 can help avoid the risk of bearing joint assembly damage when a seal fails, lubricant leaks from a seal, and/or contaminants infiltrate a seal.

The elastomeric bearing 50 includes the outer race 58, the inner race 60, and a plurality of alternating elastomeric layers 91, 92, 93 and metal plies 97, 98. In the illustrated embodiment, the elastomeric bearing 50 includes three elastomeric layers 91, 92, 93 with two metal plies 97, 98 interposed therebetween such that the elastomeric layers 91, 92, 93 are separated from an adjacent elastomeric layer by an intervening metal ply.

Each metal ply 97, 98 preferably comprises steel or another suitable material capable of withstanding the load and stresses applied to the elastomeric bearing 50 during normal operating conditions involved with any particular work machine application. Each elastomeric layer 91, 92, 93 preferably comprises any suitable resilient material capable of withstanding the particular loads involved with any particular work machine application, and preferably absorbs and/or dampens a portion of the load applied thereto. The outer and inner races 58, 60 preferably comprise steel or another suitable material capable of withstanding the load and stresses applied to the elastomeric bearing 50 during normal operating conditions involved with any particular work machine application.

The elastomeric bearing 50 includes first and second subassemblies 101, 102 that inner ends 104, 105 are in adjoining relationship at a midline plane 107. The first and second subassemblies 101, 102 cooperate together to define the outer race 58, the inner race 60, and the plurality of alternating elastomeric layers 91, 92, 93 and the metal plies 97, 98. Embodiments of the elastomeric bearing 50 can be split into two or more subassemblies 101, 102 to help reduce the manufacturing costs for the elastomeric bearing. The split bearing design can facilitate the manufacturability of the elastomeric bearing 50 by segmenting the elastomeric bearing 50 into subassemblies 101, 102 with geometric configurations that are more readily manufactured using conventional techniques, such as injection molding, for example. The split bearing design also facilitates the generation of pre-strain loading in the elastomeric bearing 50 as described below. In other embodiments, the elastomeric bearing 50 can comprise a different number of subassemblies 101, 102, which can also vary depending upon the particular application with which a particular bearing is involved.

At each outer end 108, 109 of the first and second subassemblies 101, 102, the bearing joint assembly 44 includes a pin-engaging snap ring 112 which is adapted to be in retentive engagement with the pin 52 and is configured to be disposed within a respective groove 114 defined in an exterior surface 115 of the pin 52. At each outer end 108, 109 of the first and second subassemblies 101, 102, the bearing joint assembly 44 also includes an equalizer bar-engaging snap ring 118 which is adapted to be in retentive engagement with the equalizer bar 34 and is configured to be disposed within a groove 120 defined in an interior surface 122 of the first distal end 38 of the equalizer bar 34 that also defines the through passage 54 in which the elastomeric bearing 50 is disposed. The pin-engaging snap rings 112 and the equalizer bar-engaging snap rings 118 function to hold the first and second subassemblies 101, 102 in proper operative position with each other such that the inner ends 104, 105 of the first and second subassemblies 101, 102 are in adjoining relationship with each other along the midline plane 107 and a pre-strain load is generated in the elastomeric bearing 50. The pin-engaging snap rings 112 and the equalizer bar-engaging snap rings 118 also function to place the elastomeric bearing 50 into engagement with the pin 52 and the equalizer bar 34. In other embodiments, the bearing joint assembly 44 can include other means for bringing the first and second subassemblies 101, 102 together and engaging the pin 52 and the equalizer bar 34.

The first distal end 38 of the equalizer bar 34 and the outer race 58 of the elastomeric bearing 50 are in engaging contact with each other such that the outer race 58 and the first distal end 38 of the equalizer bar 34 are coupled together to prevent relative movement therebetween. The engaging contact between the outer race 58 of the elastomeric bearing 50 and the first distal end 38 of the equalizer bar 34 can be established via a press-fit arrangement between the interior surface 122 of the first distal end 38 and an exterior surface 127 of the outer race 58.

In the illustrated embodiment, the elastomeric bearing 50 has a length “L₁,” measured along the longitudinal axis “LA,” of about 140 mm. In other embodiments, the length “L₁” of the elastomeric bearing 50 can be different. In the illustrated embodiment, the lengths “L₂,” “L₃” of the first and second subassemblies 101, 102 are substantially the same and are about 70 mm. In other embodiments, the lengths “L₂,” “L₃” of the first and second subassemblies 101, 102 can be different. In still other embodiments, the lengths “L₂,” “L₃” of the first and second subassemblies 101, 102 can be different from each other.

In the illustrated embodiment, an interior surface 125 of the inner race 60 defines the axial passage 51 of the elastomeric bearing 50 and is substantially cylindrical. The interior surface 125 of the inner race 60 defines an inner diameter “ID” of the elastomeric bearing 50. The illustrated inner diameter “ID” of the elastomeric bearing 50 is about 88.9 mm. In other embodiments, the inner diameter “ID” of the elastomeric bearing 50 can be different. In the illustrated embodiment, the exterior surface 127 of the outer race 58 is substantially cylindrical and defines an outer diameter “OD” of the elastomeric bearing 50. The illustrated outer diameter “OD” of the elastomeric bearing 50 is about 158 mm. In other embodiments, the outer diameter “OD” of the elastomeric bearing 50 can be different. In still other embodiments, the interior surface 125 of the inner race 60 and/or the exterior surface 127 of the outer race 58 can have different shapes, such as oval-shaped, elliptical, etc.

In the illustrated embodiment, each elastomeric layer 91, 92, 93 has a different thickness “T₁,” T₂,” “T₃,” which can be measured along an axis that is perpendicular to both opposing surfaces of the particular elastomeric layer 91, 92, 93 in question, or to tangential axes taken from opposing surfaces in the case where the elastomeric layer 91, 92, 93 in question is arcuate. The thickness “T₁,” T₂,” “T₃” of each elastomeric layer 91, 92, 93 is different from all of the other elastomeric layers 91, 92, 93. In some embodiments, the thickness “T₁,” T₂,” “T₃” of each elastomeric layer 91, 92, 93 can vary such that the first elastomeric layer 91, which is closest to the inner race 60, is thinner than the second and third elastomeric layers 92, 93, and the second elastomeric layer 92 is thinner than the third elastomeric layer 93, which is closest to the outer race 58. In the illustrated embodiment, the elastomeric layers 91, 92, 93 each have a thickness “T₁,” T₂,” “T₃” of about 4 mm, 6 mm, and 8 mm, respectively. In other embodiments, the elastomeric layers 91, 92, 93 can have a thickness “T₁,” T₂,” “T₃” in a range from about 2 mm to about 12 mm. In still other embodiments, the elastomeric layers 91, 92, 93 can have a thickness “T₁,” T₂,” “T₃” in a different range.

In other embodiments, the elastomeric layers 91, 92, 93 can each have substantially the same thickness “T₁,” T₂,” “T₃.” In other embodiments, the thicknesses “T₁,” T₂,” “T₃” of at least one elastomeric layer 91, 92, 93 can be different from at least one other elastomeric layer 91, 92, 93.

In the illustrated embodiment, the metal plies 97, 98 each have substantially the same thickness “T₄,” “T₅,” which can be measured along an axis that is perpendicular to both opposing surfaces of the particular metal ply 97, 98 in question, or to tangential axes taken from opposing surfaces in the case where the metal ply 97, 98 in question is arcuate. In the illustrated embodiment, the metal plies 97, 98 each have a thickness “T₄,” “T₅” of about 2 mm. In other embodiments, the metal plies 97, 98 can have a thickness “T₄,” “T₅” in a range from about 2 mm to about 5 mm. In still other embodiments, the metal plies 97, 98 can have a thickness “T₄,” “T₅” in a different range.

In other embodiments, the thicknesses “T₄,” “T₅” of at least one metal ply 97, 98 can be different from at least one other metal ply 97, 98. In yet other embodiments where the elastomeric bearing 50 includes three or more metal plies, the thickness “T₄,” “T₅” of each metal ply can be different from all of the other metal plies.

In still other embodiments, the thickness of at least one elastomeric layer 91, 92, 93 can vary along the longitudinal axis “LA” such that the thickness of the particular elastomeric layer 91, 92, 93 is different in at least two points along the longitudinal axis “LA.” In yet other embodiments, the thickness of at least one metal ply 97, 98 can vary along the longitudinal axis “LA” such that the thickness of the particular metal ply 97, 98 is different in at least two points along the longitudinal axis “LA.”

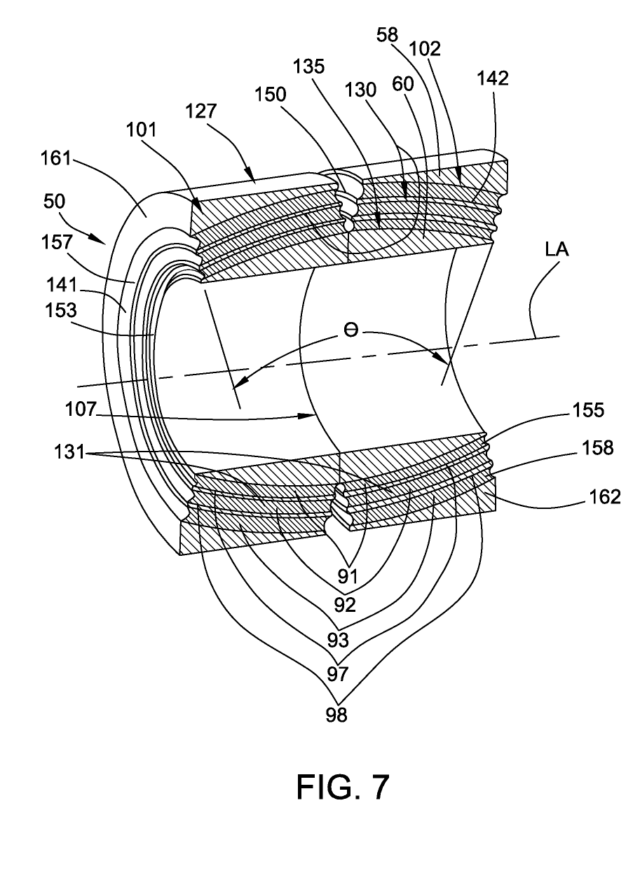

The illustrated elastomeric layers 91, 92, 93 and metal plies 97, 98 have an arcuate shape in cross-section. Adjoining elastomeric layers 91, 92, 93 and metal plies 97, 98 can have a complementary radius of curvature. The elastomeric layers 91, 92, 93 and metal plies 97, 98 can have a curvature to help accommodate the relative rotational motion therebetween as either pitch or yaw. In the illustrated embodiment, the elastomeric layers 91, 92, 93 and the metal plies 97, 98 define a pair of annular arcs 130, 131 in a plane that intersects the longitudinal axis “LA.” The illustrated annular arcs 130, 131 are substantially the same. As such, the following description of one annular arc 130 should be understood to apply to the other annular arc 131, as well. The annular arc 130 is generally circular and includes an inner radius of curvature “Rᵢ” of 195 mm, an outer radius of curvature “Rₒ” of 217 mm, and a central angle “θ” of 42.5° (see FIG. 7). The various thicknesses “T₁,” T₂,” “T₃” of the elastomeric layers 91, 92, 93 and thicknesses “T₄,” “T₅” of the metal plies 97, 98 define other radii of curvature within the annular arc 130, which can vary depending upon the thicknesses “T₁,” T₂,” “T₃” of the elastomeric layers 91, 92, 93 and the thicknesses “T₄,” “T₅” of the metal plies 97, 98 which comprise the annular arc 130. An exterior surface 135 of the inner race 60 substantially conforms to the inner radius of curvature “Rᵢ” of the annular arc 130. An interior surface 137 of the outer race 58 substantially conforms to the outer radius of curvature “Rₒ” of the annular arc 130.

The illustrated values for the inner radius of curvature “Rᵢ,” the outer radius of curvature “Rₒ,” and the central angle “0” are exemplary in nature. In other embodiments, at least one of the inner radius of curvature “Rᵢ,” the outer radius of curvature “Rₒ,” and the central angle “θ” can be varied. These parameters can be varied to improve strain characteristics, to meet different load/motion requirements, and/or to accommodate different geometric constraints, for example. As an example, in some embodiments, the inner radius of curvature “Rᵢ” can be decreased and the outer radius of curvature “Rₒ” can be increased. In other embodiments, the outer radius of curvature “Rₒ” can be increased so that it approaches infinity, in other words, substantially no curvature. In still other embodiments, the annular arc 130 can be generally parabolic.

In other embodiments, the elastomeric layers 91, 92, 93 and the metal plies 97, 98 can be different lengths. For example, in some embodiments, the elastomeric bearing 50 can taper, either inwardly or outwardly, as a function of radial distance from the inner diameter “ID” to the outer diameter “OD” of the elastomeric bearing 50.

The multiple elastomeric layers 91, 92, 93 and the metal plies 97, 98 can be provided to help carry the load and accommodate the relative translation and rotational movement of the elastomeric bearing 50 during use of the machine. In some embodiments, the elastomeric bearing 50 can include at least two elastomeric layers with an intervening metal ply between adjacent elastomeric layers. In still other embodiments, a different plurality of alternating layers of elastomeric layers and metal plies can be utilized depending upon the particular application involved.

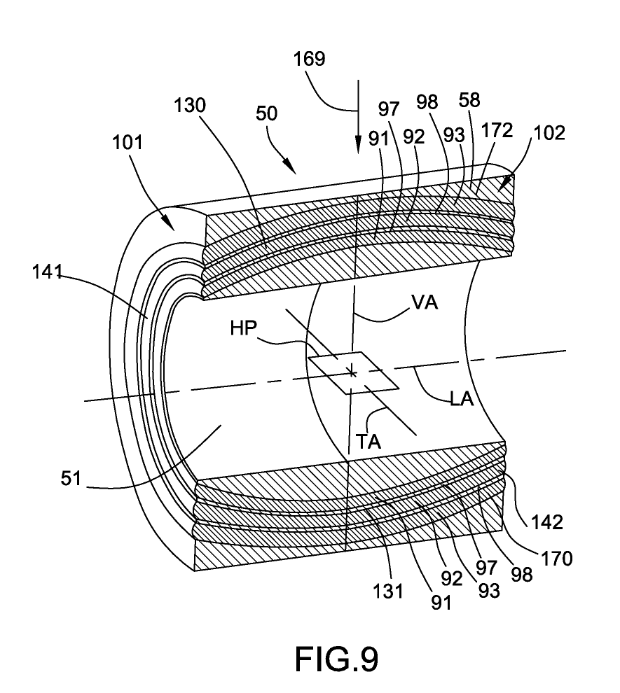

When the elastomeric bearing 50 is subjected to loading conditions, some portion of the elastomeric layers 91, 92, 93 can be placed into tension and another portion into compression. In some cases, the elastomeric portion in tension may be subjected to a state of hydrostatic stress, which can lead to cavitation damage. For example, loading the elastomeric bearing 50 from above along the vertical axis “VA” such that the load is being applied to the outer race 58 in a downward direction 169 can place the elastomeric layers 91, 92, 93 in a lower portion 170 that is disposed below the horizontal plane “HP” in tension and in an upper portion 172 above the central horizontal plane “HP” in compression (see FIG. 9). Furthermore, the elastomeric bearing 50 may be subjected to cyclic loading conditions where loading may vary in magnitude or direction. For example, if the loading is partially or fully reversed, elastomeric portions that had been subjected to tension could be placed into compression and vice versa. Cyclic loading can cause stress or strain cycling in amplitude or direction, which can lead to fatigue damage in the elastomeric layers 91, 92, 93. In some embodiments, the elastomeric layers 91, 92, 93 of the elastomeric bearing 50 can be placed into a pre-compressed state such that any hydrostatic tensile stresses in the elastomeric layers 91, 92, 93 remain below a predetermined level while being subjected to a given load to help reduce cavitation damage. In some embodiments, the elastomeric layers 91, 92, 93 can be placed into a pre-compressed state such that cyclic stress or strain amplitudes in the elastomeric layers 91, 92, 93 remain below a predetermined level while being subjected to a given cyclic loading condition to help reduce fatigue damage.

Referring to FIG. 7, the elastomeric bearing 50 is shown in an unassembled state. The first and second subassemblies 101, 102 are disposed in adjoining relationship to each other. The portions 141, 142 of the respective first and second subassemblies 101, 102 that comprise the elastomeric layers 91, 92, 93 and the metal plies 97, 98 are offset from each other at the midline plane 107 along the longitudinal axis “LA” in graduating increments as a function of radial distance from the longitudinal axis “LA.” The offset relationship of the portions 141, 142 of the first and second subassemblies 101, 102 that comprise the elastomeric layers 91, 92, 93 and the metal plies 97, 98 when in the assembled condition define a generally V-shaped circumferential groove 150 about the longitudinal axis “LA” that extends radially from the exterior surface 127 of the outer race 58 to the exterior surface 135 of the inner race 60. The portions 153, 155 of the first and second subassemblies 101, 102 that comprise the first elastomeric layer 91 are closest to each other, and the portions 157, 158 of the first and second subassemblies 101, 102 that comprise the third elastomeric layer 93 are farthest apart from each other.

The elastomeric bearing 50 can be subjected to an axial compressive pre-load by forcing the portions 161, 162 of the first and second subassemblies 101, 102 that comprise the outer race 58 to axially approach each other along the longitudinal axis “LA” to close the V-shaped circumferential groove 150 between the portions 141, 142 of the respective first and second subassemblies 101, 102 that comprise the elastomeric layers 91, 92, 93 and the metal plies 97, 98 (see FIG. 9). The first and second subassemblies 101, 102 can be held in place axially by the pin-engaging snap rings 112 and the equalizer bar-engaging snap rings 118.

The manufacture and assembly of multiple swaged layers can be a costly process. A bearing joint assembly according to principles of the present disclosure can include a preloaded elastomeric bearing 50 without the need for swaging by using the offset layer configuration described above.

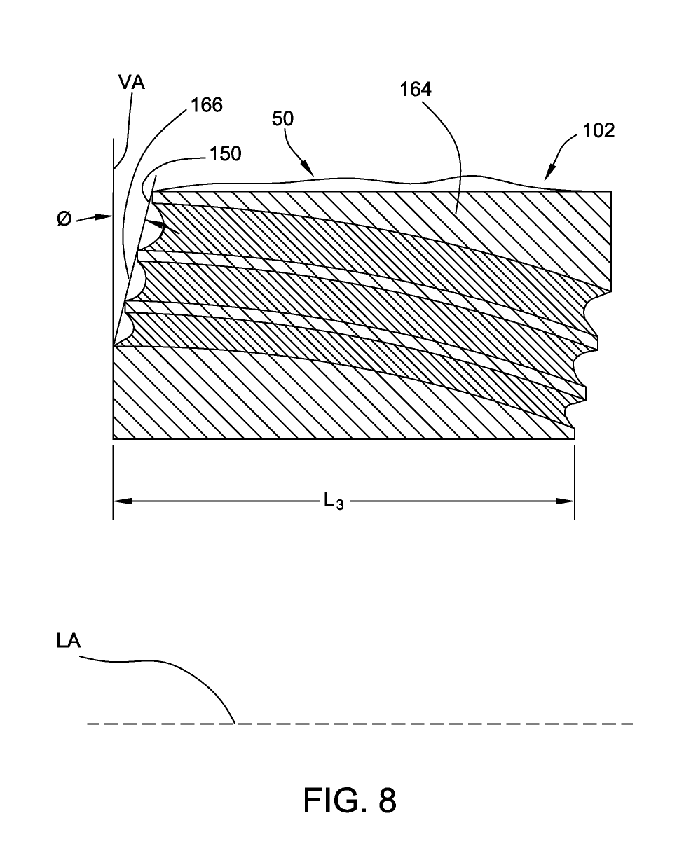

Referring to FIG. 8, a portion 164 of the second subassembly 102 is shown in an unassembled condition and includes a side 166 of the V-shaped circumferential groove 150. The side 166 is disposed at an offset angle ø relative to the vertical axis “VA” and defines a slope of the V-shaped circumferential groove 150. In the illustrated embodiments, the offset angle ø is about 18.1°. In other embodiments, the offset angle ø can be in a range up to about 30° in some embodiments, in a range between about 5° and about 30° in other embodiments, and in a range between about 10° and about 30° in yet other embodiments. In still other embodiments, the offset angle ø can be varied to generate a desired amount of pre-strain in the elastomeric bearing when the portions of the subassemblies comprising the outer race are driven together. In yet other embodiments, one or both sides 166 of the groove 150 can be curved (e.g., a convex or a concave curve) or have a non-planar shape.

Referring to FIG. 9, to help reduce elastomeric strains at the edges of the elastomeric bearing 50 when undergoing relative rotation as pitch (e.g., ±2.1°) about the transverse axis “TA,” the elastomeric bearing 50 can include a generally spherical segment configuration. The arrangement of the elastomeric layers 91, 92, 93 and the metal plies 97, 98 provides a generally spherical segment which can help reduce stresses and strains in the elastomeric layers 91, 92, 93 generated by relative rotation, such as, as pitch or yaw, by accommodating the rotation through shear in the layers, rather than compression or tension.

Referring to FIG. 6, the first and second subassemblies 101, 102 are substantially similar to each other and are configured as mirror images about the midline plane 107 so that the elastomeric bearing 50 is substantially symmetrical about its midline plane 107, which is perpendicular to the longitudinal axis “LA.” Referring to FIG. 9, the elastomeric layers 91, 92, 93 and the metal plies 97, 98 are generally barrel-shaped. The longitudinal axis “LA” of the elastomeric bearing 50 constitutes an axis of revolution about which the annular arcs 130, 131 are rotated such that the elastomeric bearing 50 is substantially symmetrical about the longitudinal axis “LA” extending centrally through the axial passage 51.

In other embodiments, the elastomeric bearing 50 can be asymmetrical about at least one axis. For example, the intended static load for which the elastomeric bearing is used to support may frequently act in a single primary direction. Dynamic loading can be biased in the same direction as the primary line of action of the static load. In some embodiments, such as where the primary loading acts along the vertical axis “VA,” the elastomeric bearing 50 can be asymmetrically arranged around a central horizontal plane “HP,” defined by the longitudinal axis “LA” and the transverse axis “TA.” In one arrangement, particular elastomeric layers and metal plies can have different radii of curvature in a lower portion 170 of the elastomeric bearing 50 that is disposed below the horizontal plane “HP” than the radii of curvature for an upper portion 172 above the central horizontal plane “HP.”

Further, in some embodiments, the thickness of the elastomeric layers can vary so that the layers are thinner in regions where the primary loading creates a tendency for the layers to be placed in compression and thicker in regions where the primary loading creates a tendency for the layers to be placed in tension. For example, the thickness of a given elastomeric layer can vary such that the thickness of the elastomeric layer is different in the lower portion 170 disposed below the horizontal plane “HP” than it is in the upper portion 172 disposed above the horizontal plane “HP.” In one arrangement, such as where the primary loading acts from above the elastomeric bearing 50 along the vertical axis “VA,” the thickness of a given elastomeric layer can be thicker in the lower portion 170 disposed below the horizontal plane “HP” than it is in the upper portion 172 disposed above the horizontal plane “HP.” In some embodiments, the thickness of a given elastomeric layer can vary gradually from the uppermost part of the upper portion 172 to the bottommost portion of the lower portion 170.

In one embodiment, a method of making an elastomeric bearing 50 for a bearing joint assembly 44 includes abutting a first subassembly 101 and a second subassembly 102. An inner end 104 of the first subassembly 101 and an inner end 105 of the second subassembly 102 are abutted in adjoining relationship to each other and define a circumferential groove 150 therebetween. The first subassembly 101 and the second subassembly 102 form an inner race 60 extending along a longitudinal axis “LA,” an outer race 58 coaxially arranged with the inner race 60, a plurality of elastomeric layers 91, 92, 93 disposed between the outer race 58 and the inner race 60 and defining at least one pair of adjacent elastomeric layers 91, 92, 93, and a metal ply 97, 98 interposed between the elastomeric layers 91, 92, 93 of at least one pair of adjacent elastomeric layers. The first subassembly 101 and the second subassembly 102 are moved to axially approach each other along the longitudinal axis “LA” to close the circumferential groove 150 defined between the first subassembly 101 and the second subassembly 102, thereby generating an axial compressive pre-load in at least a portion of one of the elastomeric layers 91, 92, 93.

In some embodiments of a method of making an elastomeric bearing, the elastomeric layers 91, 92, 93 are adapted to permit relative rotation and translation between the outer race 58 and the inner race 60. In yet other embodiments of a method of making an elastomeric bearing, the first subassembly 101 and the second subassembly 102 each includes a side 166 of the circumferential groove 150. The circumferential groove 150 is substantially-V-shaped. In still other embodiments, each side 166 of the first and the second subassemblies 101, 102 is disposed at an offset angle ø relative to a vertical axis “VA.” The vertical axis “VA” is substantially perpendicular to the longitudinal axis “LA.” The offset angle ø is in a range up to about 30°.

### Industrial Applicability

The industrial applicability of the embodiments of an elastomeric bearing and a bearing joint assembly described herein will be readily appreciated from the foregoing discussion. At least one embodiment of the disclosed elastomeric bearings 50 may be used for a bearing joint assembly 44, 45. At least one embodiment of the disclosed bearing joint assemblies 44, 45 can be used in an undercarriage 12 of a track-type machine 10. At least one embodiment provides a bearing joint assembly 44, 45 that does not require lubrication.

Embodiments of an elastomeric bearing, a bearing joint assembly, and an undercarriage according to principles of the present disclosure may find potential application in any machine, such as a track-type tractor, which utilizes a track-type undercarriage. Such machines may include, but are not limited to, dozers, loaders, excavators, or any other on-highway or off-highway vehicles or stationary machines that utilize a track assembly, as described herein.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. An elastomeric bearing for a bearing joint assembly, the elastomeric bearing comprising:
an inner race extending along a longitudinal axis;
an outer race coaxially arranged with the inner race;
a plurality of elastomeric layers disposed between the outer race and the inner race, the elastomeric layers defining at least one pair of adjacent elastomeric layers;
and a metal ply interposed between the elastomeric layers of at least one pair of adjacent elastomeric layers;
wherein the elastomeric layers are adapted to permit relative rotation and translation between the outer race and the inner race, and at least a portion of one of the elastomeric layers is in a pre-compressed state.

2. The elastomeric bearing of claim 1, wherein the elastomeric layers are in a pre-compressed state such that any hydrostatic tensile stresses in the elastomeric layers remain below a predetermined level while being subjected to a particular load.

3. The elastomeric bearing of claim 1, wherein the elastomeric layers are in a pre-compressed state such that cyclic stress or strain amplitudes in the elastomeric layers remain below a predetermined level while being subjected to a particular cyclic loading condition.

4. The elastomeric bearing of claim 1, wherein the inner race, the outer race, the elastomeric layers, and the metal ply are formed from a first subassembly and a second subassembly.

5. The elastomeric bearing of claim 1, wherein the outer race and the inner race are pivotable with respect to each other about the longitudinal axis over a range of travel of at least about ±3.5°.

6. The elastomeric bearing of claim 5, wherein the outer race and the inner race are pivotable with respect to each other about a transverse axis in a vertical plane over a range of travel of at least about ±1.5°, and the outer race and the inner race are pivotable with respect to each other about a vertical axis in a horizontal plane over a range of travel of at least about ±0.1°, the transverse axis being substantially perpendicular to the longitudinal axis, the longitudinal axis and the transverse axis defining the horizontal plane, the vertical axis being substantially perpendicular to the longitudinal axis and the transverse axis, and the longitudinal axis and the vertical axis defining the vertical plane.

7. The elastomeric bearing of claim 1, wherein the elastomeric layers are subjected to an axial compressive pre-load.

8. The elastomeric bearing of claim 7, wherein the inner race, the outer race, the elastomeric layers, and the metal ply are formed from a first subassembly and a second subassembly, the first subassembly and the second subassembly each having an inner end, the inner end of the first subassembly and the inner end of the second subassembly being in adjoining relationship to each other and defining a circumferential groove therebetween, the axial compressive pre-load generated by moving the first subassembly and the second subassembly to axially approach each other along the longitudinal axis to close the circumferential groove defined between the first subassembly and the second subassembly.

9. The elastomeric bearing of claim 8, comprising:
three elastomeric layers disposed between the outer race and the inner race, the three elastomeric layers defining two pairs of adjacent elastomeric layers;
two metal plies respectively interposed between the elastomeric layers of the two pairs of adjacent elastomeric layers.

10. The elastomeric bearing of claim 9, wherein the elastomeric layers and the metal plies define a generally spherical segment.

11. The elastomeric bearing of claim 9, wherein the two metal plies have substantially the same thickness.

12. The elastomeric bearing of claim 9, wherein at least one of the elastomeric layers has a different thickness than at least one other of the elastomeric layers.

13. The elastomeric bearing of claim 12, wherein the two metal plies have substantially the same thickness.

14. A bearing joint assembly comprising:
an elastomeric bearing, the elastomeric bearing defining an axial passage extending therethrough along a longitudinal axis; and
a pin, the pin being disposed in the axial passage of the elastomeric bearing and extending along the longitudinal axis; and
wherein the elastomeric bearing includes:
an inner race extending along the longitudinal axis, the inner race in engaging contact with the pin such that the inner race and the pin are coupled together to prevent relative movement therebetween,
an outer race coaxially arranged with the inner race,
a plurality of elastomeric layers disposed between the outer race and the inner race, the elastomeric layers defining at least one pair of adjacent elastomeric layers, and
a metal ply interposed between the elastomeric layers of at least one pair of adjacent elastomeric layers,
wherein the elastomeric layers are adapted to permit relative rotation and translation between the outer race and the inner race, and at least a portion of one of the elastomeric layers is in a pre-compressed state.

15. The bearing joint assembly of claim 14, wherein the bearing joint assembly comprises a maintenance-free joint.

16. The bearing joint assembly of claim 14, wherein the pin and the inner race are separate components.

17. An undercarriage comprising:
a main frame having a first side;
a first track assembly disposed on the first side of the main frame;
an equalizer bar pivotably connected to the main frame, the equalizer bar including a first distal end; and
a first bearing joint assembly, the first distal end of the equalizer bar being pivotably connected to the first track assembly via the first bearing joint assembly, the first bearing joint assembly including:
an elastomeric bearing, the elastomeric bearing defining an axial passage extending therethrough along a longitudinal axis, and
a pin, the pin being disposed in the axial passage of the elastomeric bearing and extending along the longitudinal axis, and
wherein the elastomeric bearing includes:
an inner race extending along the longitudinal axis, the inner race in engaging contact with the pin such that the inner race and the pin are coupled together to prevent relative movement therebetween,
an outer race coaxially arranged with the inner race,
a plurality of elastomeric layers disposed between the outer race and the inner race, the elastomeric layers defining at least one pair of adjacent elastomeric layers, and
a metal ply interposed between the elastomeric layers of at least one pair of adjacent elastomeric layers,
wherein the elastomeric layers are adapted to permit relative rotation and translation between the outer race and the inner race, and at least a portion of one of the elastomeric layers is in a pre-compressed state.

18. The undercarriage of claim 17, wherein the main frame has a second side in opposing relationship to the first side, and the equalizer bar includes a second distal end, the undercarriage further comprising:
a second track assembly disposed on the second side of the main frame;
a second bearing joint assembly, the second distal end of the equalizer bar being pivotably connected to the second track assembly via the second bearing joint assembly;
wherein the second bearing joint assembly includes:
an elastomeric bearing, the elastomeric bearing defining an axial passage extending therethrough along a longitudinal axis, and
a pin, the pin being disposed in the axial passage of the elastomeric bearing and extending along the longitudinal axis; and
wherein the elastomeric bearing includes:
an inner race extending along the longitudinal axis, the inner race in engaging contact with the pin such that the inner race and the pin are coupled together to prevent relative movement therebetween,
an outer race coaxially arranged with the inner race,
a plurality of elastomeric layers disposed between the outer race and the inner race, the elastomeric layers defining at least one pair of adjacent elastomeric layers, and
a metal ply interposed between the elastomeric layers of at least one pair of adjacent elastomeric layers,
wherein the elastomeric layers are adapted to permit relative rotation and translation between the outer race and the inner race, and at least a portion of one of the elastomeric layers is in a pre-compressed state.

19. The undercarriage of claim 17, wherein the first distal end of the equalizer bar and the outer race of the elastomeric bearing are in engaging contact with each other such that the outer race and the first distal end of the equalizer bar are coupled together to prevent relative movement therebetween, and the pin is coupled to the first track assembly to prevent relative movement therebetween.

20. The undercarriage of claim 19, wherein the first bearing joint assembly is adapted to permit relative rotation between the equalizer bar and the first track assembly with at least three degrees of rotational freedom and adapted to permit relative translation between the equalizer bar and the first track assembly along the longitudinal axis.
